(19) United States
(12) Patent Application Publication
(10) Pub. No.: US 2018/0300052 A1
(43) Pub. Date: Oct. 18, 2018

(54) OPERATION INPUT APPARATUS, INFORMATION PROCESSING APPARATUS, INFORMATION PROCESSING METHOD, AND PROGRAM

(71) Applicant: SONY CORPORATION, TOKYO (JP)

(72) Inventor: YASUHIRO ICHINAKA, KANAGAWA (JP)

(21) Appl. No.: 15/767,437

(22) PCT Filed: Sep. 23, 2016
(86) PCT No.: PCT/JP2016/004316

§ 371 Date: Apr. 11, 2018

(30) Foreign Application Priority Data
Oct. 26, 2015 (JP) 2015-210046

(51) Int. Cl. G06F 3/0488; G11B 27/00; G06F 3/0484

(52) U.S. Cl. CPC G06F 3/04883; G06F 2203/04808; G06F 3/04847; G11B 27/005

(57) ABSTRACT

This operation input apparatus includes: a display unit; a touch sensor panel disposed on a display screen; and a control circuit that performs control to display a rotational operation element on the display screen, determines the number of operation points according to a user's touch with respect to the rotational operation element on the basis of an output of the touch sensor panel, and performs, on the basis of the determined number of operation points, switching between a first operation mode for generating a jump command for jumping a reproduction position of information that is a reproduction target by a distance depending on an operation rotational angle of the rotational operation element and a second operation mode for generating a fast-forward command for fast-forward-reproducing the information at a speed depending on the operation rotational angle of the rotational operation element.

### TECHNICAL FIELD

The present technology relates to an operation input apparatus, an information processing apparatus, an information processing method, and a program that are favorable for an operation of designating a position of information such as audio and video on a time axis, for example.

### BACKGROUND ART

In an operation input apparatus such as a remote control apparatus, a jog dial is sometimes used as an operation element.

Patent Literature 1 discloses a remote control apparatus installing a mechanical jog dial. In this remote control apparatus, a jog button, a shuttle button, and the like are provided near the jog dial. In accordance with Patent Literature 1, the jog dial is enabled when the jog button or the shuttle button is pressed. In addition, information for changing a speed in a manner that depends on a rotational operation of the jog dial is obtained when the shuttle button is pressed.

Patent Literature 2 discloses a jog dial displayed as one of graphical user interfaces on a display device and used for increasing or decreasing a value of numerical value information

### CITATION LIST

### Patent Literature

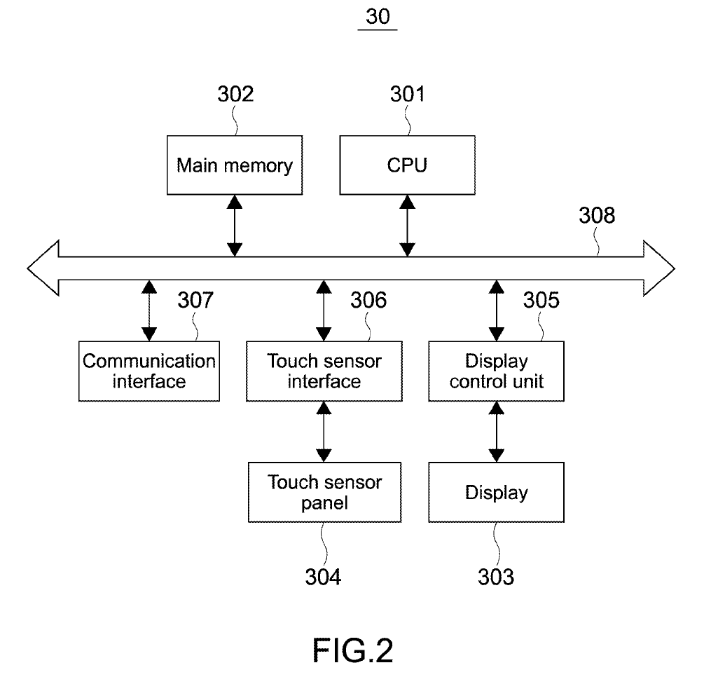

Patent Literature 1: Japanese Patent Application Laid-open No. HEI09-282847 (paragraph [0013], FIG. 2, etc.)

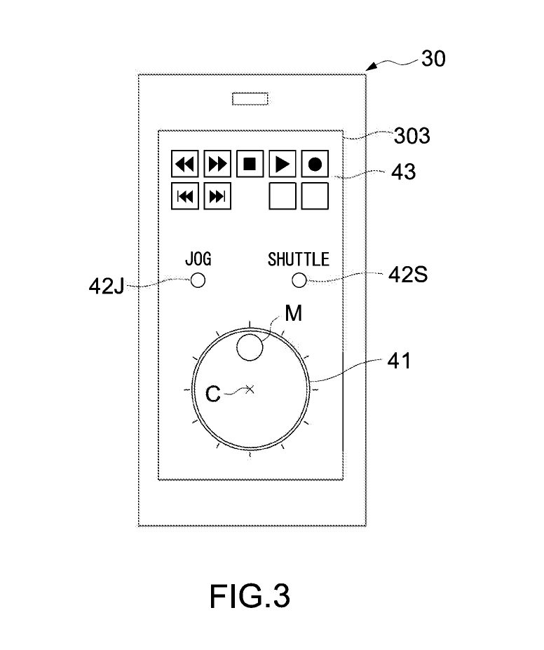

Patent Literature 2: Japanese Patent Application Laid-open No. HEI08-030270 (paragraph [0020], FIG. 3, etc.)

### DISCLOSURE OF INVENTION

### Technical Problem

However, user interfaces using the jog dial still have problems to be improved in various points, particularly, operability, and it is desirable to solve them.

In view of the above-mentioned circumstances, it is an object of the present technology to provide an operation input apparatus, an information processing apparatus, an information processing method, and a program and an operation input method, by which an improvement in operability in operating a reproduction position of information can be achieved.

### Solution to Problem

In order to solve the above-mentioned problems, an operation input apparatus of an embodiment according to the present technology includes:

a display unit including a display screen;

a touch sensor panel disposed on the display screen; and

a control circuit that
performs control to display a rotational operation element on the display screen,
determines the number of operation points according to a user's touch with respect to the rotational operation element on the basis of an output of the touch sensor panel, and
performs, on the basis of the determined number of operation points, switching between a first operation mode for generating a jump command for jumping a reproduction position of information that is a reproduction target by a distance depending on an operation rotational angle of the rotational operation element and a second operation mode for generating a fast-forward command for fast-forward-reproducing the information at a speed depending on the operation rotational angle of the rotational operation element.

The control circuit may be configured to

set the first operation mode when the determined number of operation points is M (M is a number equal to or larger than 1), and

set the second operation mode when the determined number of operation points is N (N is a predetermined number larger than M).

The control circuit may be

configured to perform switching to set the second operation mode when the number of operation points according to the user's touch with respect to the rotational operation element is changed from M to N on the set first operation mode, and

configured to perform switching to set the first operation mode when the number of operation points according to the user's touch with respect to the rotational operation element is changed from N to M on the set second operation mode.

Further, the operation input apparatus of the embodiment according to the present technology may further include

a communication interface for communication with an information reproduction apparatus capable of reproducing information, in which

the control circuit may be configured to
send the generated jump command to the information reproduction apparatus by using the communication interface on the set first operation mode, and
send the generated fast-forward command to the information reproduction apparatus by using the communication interface on the set second operation mode.

In addition, in the above-mentioned operation input apparatus,

the control circuit may be configured to
cancel the set first operation mode when the number of operation points according to the user's touch with respect to the rotational operation element is changed from M to 0 on the set first operation mode,
cancel the set second operation mode, generate a command for terminating the fast-forward reproduction of the information, and send the command to the information reproduction apparatus by using the communication interface, when the number of operation points according to the user's touch with respect to the rotational operation element is changed from N to 0 on the set second operation mode.

An information processing apparatus of another embodiment according to the present technology includes

a control circuit that
performs control to display a rotational operation element on a display screen of a display apparatus,
determines the number of operation points according to a user's touch with respect to the rotational operation element on the basis of an output of a touch sensor panel disposed on the display screen of the display apparatus, and
performs, on the basis of the determined number of operation points, switching between a first operation mode for generating a jump command for jumping a reproduction position of information that is a reproduction target by a distance depending on an operation rotational angle of the rotational operation element and a second operation mode for generating a fast-forward command for fast-forward-reproducing the information at a speed depending on the operation rotational angle of the rotational operation element.

An information processing method of still another embodiment according to the present technology includes:

by a control circuit
performing control to display a rotational operation element on a display screen of a display apparatus;
determining the number of operation points according to a user's touch with respect to the rotational operation element on the basis of an output of a touch sensor panel disposed on the display screen of the display apparatus; and
performing, on the basis of the determined number of operation points, switching between a first operation mode for generating a jump command for jumping a reproduction position of information that is a reproduction target by a distance depending on an operation rotational angle of the rotational operation element and a second operation mode for generating a fast-forward command for fast-forward-reproducing the information at a speed depending on the operation rotational angle of the rotational operation element.

A program of still another embodiment according to the present technology causes a computer as

a control circuit that
performs control to display a rotational operation element on a display screen of a display apparatus, determines the number of operation points according to a user's touch with respect to the rotational operation element on the basis of an output of a touch sensor panel disposed on the display screen of the display apparatus, and
performs, on the basis of the determined number of operation points, switching between a first operation mode for generating a jump command for jumping a reproduction position of information that is a reproduction target by a distance depending on an operation rotational angle of the rotational operation element and a second operation mode for generating a fast-forward command for fast-forward-reproducing the information at a speed depending on the operation rotational angle of the rotational operation element.

### Advantageous Effects of Invention

As described above, in accordance with the present technology, it is possible to achieve an improvement in operability in operating a reproduction position of information.

It should be noted that the effects described here are not necessarily limitative and any effect described in the present disclosure may be provided.

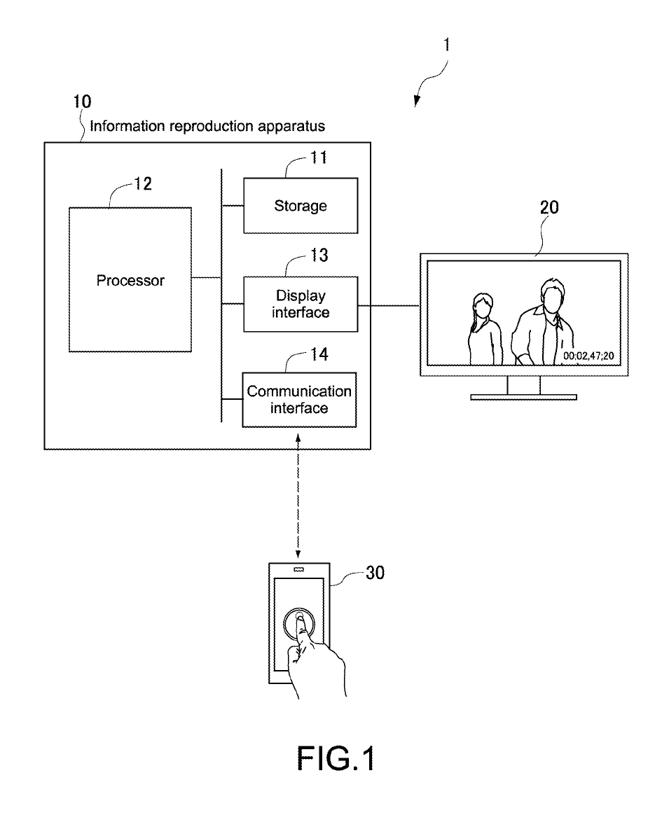

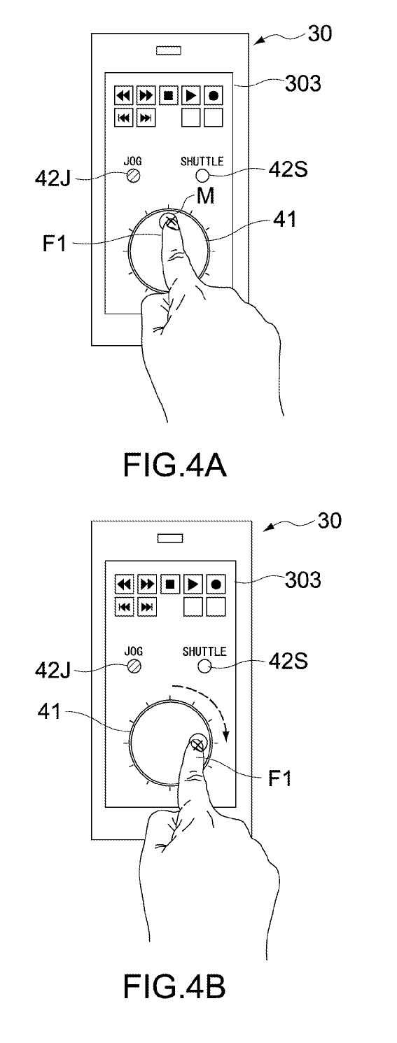

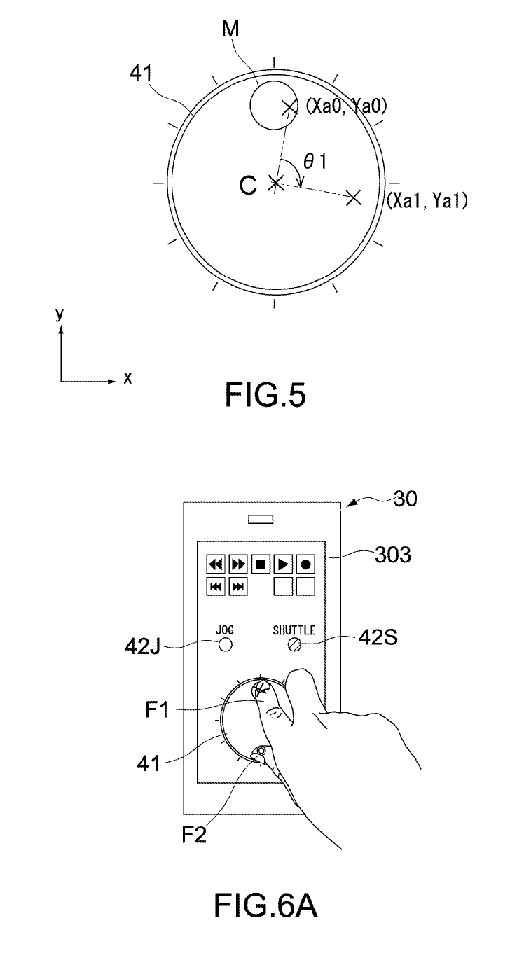

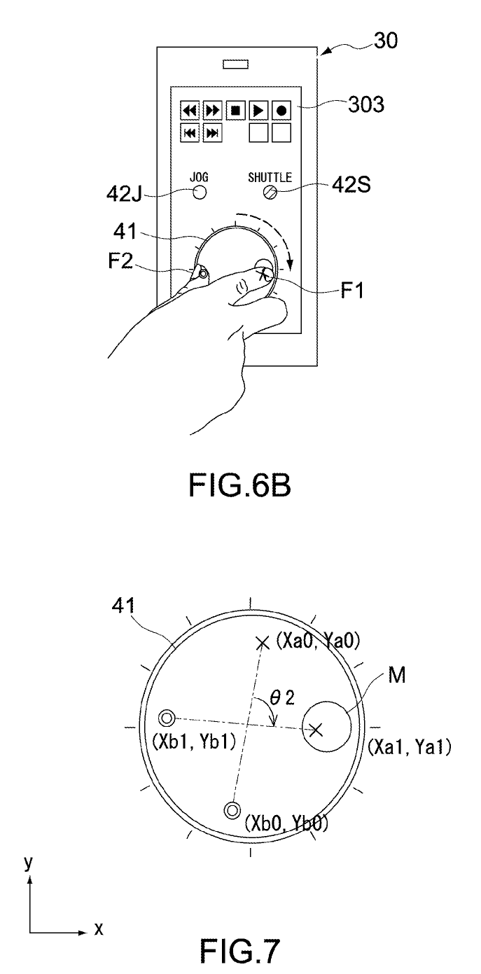

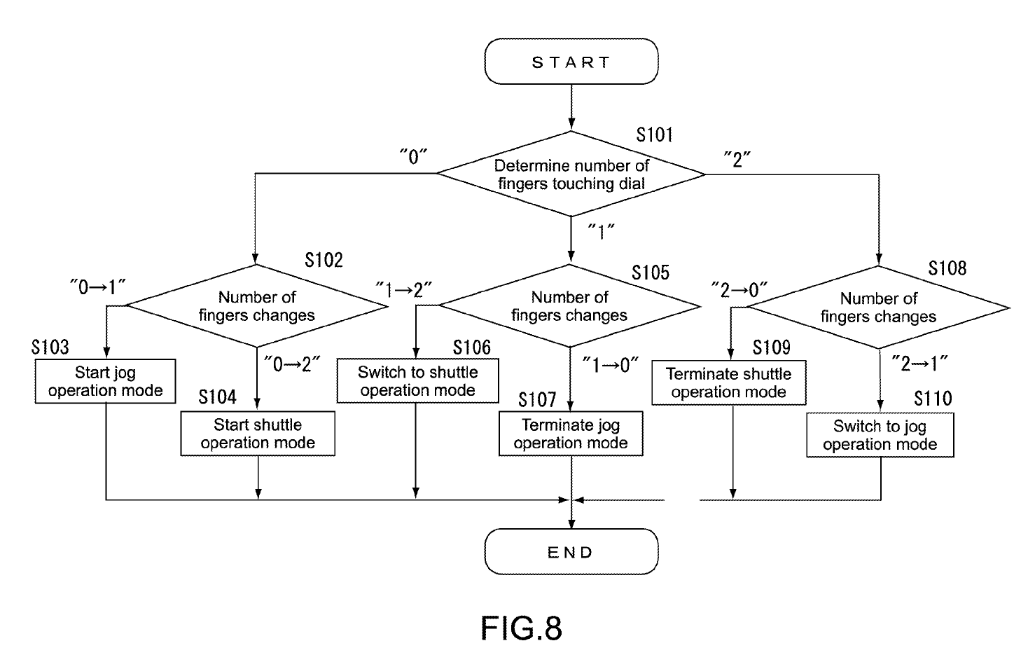

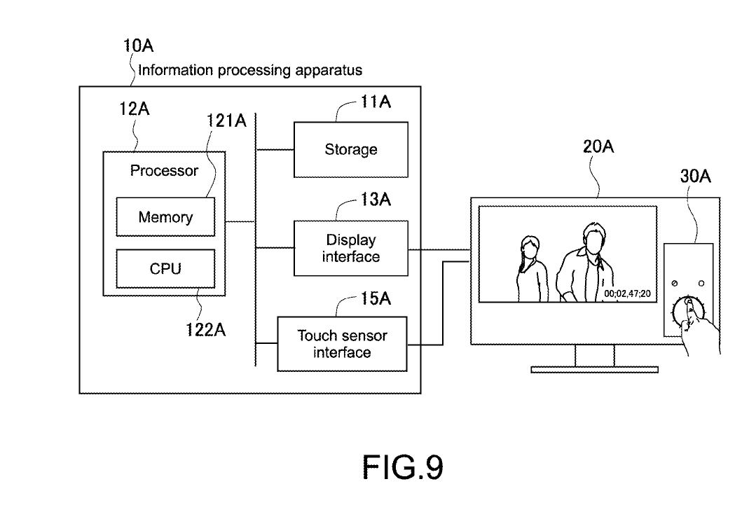

### BRIEF DESCRIPTION OF DRAWINGS

[FIG. 1] A diagram showing a configuration of an information processing system using an operation input apparatus of a first embodiment according to the present technology.

[FIG. 2] A block diagram showing a hardware configuration of an operation input apparatus 30 of FIG. 1.

[FIG. 3] A diagram showing an example of a GUI displayed on a display 303 of the operation input apparatus 30.

[FIG. 4A] A diagram showing a state at a start time of a jog operation.

[FIG. 4B] A diagram showing a state immediately before an end time of the jog operation.

[FIG. 5] A diagram showing a calculation method of a rotational operation angle of a dial 41 according to the jog operation.

[FIG. 6A] A diagram showing a state at a start time of a shuttle operation.

[FIG. 6B] A diagram showing a state immediately before an end time of the shuttle operation.

[FIG. 7] A diagram showing a calculation method of a rotational operation angle of the dial 41 according to the shuttle operation.

[FIG. 8] A flowchart about a switching operation of an operation mode of the dial 41.

[FIG. 9] A diagram showing a configuration of an information processing apparatus 10A that is a modified example of the first embodiment according to the present technology.

### MODE(S) FOR CARRYING OUT THE INVENTION

Hereinafter, an embodiment for carrying out the present invention will be described.

### First Embodiment

FIG. 1 is a diagram showing a configuration of an information processing system using an operation input apparatus of the first embodiment according to the present technology.

This information processing system 1 includes an information reproduction apparatus 10, a display apparatus 20, and an operation input apparatus 30.

The information reproduction apparatus 10 includes storage 11, a processor 12, a display interface 13, and a communication interface 14. The storage 11 stores information having a time axis, such as audio and a moving image. The processor 12 is capable of performing processing of reproduction, fast-forward, fast-rewind, jump, stop, and the like of the information stored in the storage 11, in accordance with a command from the operation input apparatus 30. The display interface 13 is for connection to the display apparatus 20. The communication interface 14 is for communication with the operation input apparatus 30.

The storage 11 includes a nonvolatile storage apparatus, for example, an HDD (Hard Disc Drive), an SSD (Solid State Drive), and the like.

The processor 12 includes a CPU (Central Processing Unit), a ROM (Read Only Memory), a main memory, and the like.

The communication interface 14 may be wired or may be wireless.

The display apparatus 20 includes, for example, a liquid-crystal display and the like. The display apparatus 20 is connected to the display interface 13 of the information reproduction apparatus 10. The display apparatus 20 displays, on a display screen, reproduction information and the like such as a moving image output from the information reproduction apparatus 10 through the display interface 13.

Note that the information reproduction apparatus 10 may include, for example, a personal computer and the like.

The operation input apparatus 30 is an apparatus for communicating with the information reproduction apparatus 10 and inputting various commands into the information reproduction apparatus 10. The operation input apparatus 30 receives an operation input from a user, generates a command corresponding to the contents of the operation input, and sends it to the information reproduction apparatus 10. The operation input apparatus 30 may be a remote controller device. Alternatively, the operation input apparatus 30 may be configured with a general-purpose terminal device such as a smartphone and a tablet terminal.

(Configuration of Operation Input Apparatus 30)

FIG. 2 is a block diagram showing a hardware configuration of the operation input apparatus 30.

The operation input apparatus 30 includes a CPU (corresponding to “control circuit” in scope of claims 301, a main memory 302, a display 303, a touch sensor panel 304, a display control unit 305, a touch sensor interface 306, a communication interface 307, and a system bus 308.

The CPU 301 is a controller that controls the respective units of the operation input apparatus 30 and executes arithmetic processing for executing an application program.

The main memory 302 includes a RAM (Random Access Memory) and the like. An operating system, an application program executed in this operating system, and various types of data necessary for operation of this application program are stored in the main memory 302.

The display 303 (display unit) includes, for example, a liquid-crystal display, an organic EL (electroluminescence) display, and the like. A GUI (Graphical User Interface) for operation input and the like are displayed on a screen of the display 303.

Under the control of the CPU 301, the display control unit 305 generates data for display corresponding to specifications of the display 303.

The touch sensor panel 304 is a device that detects coordinates of a position on the screen of the display 303, which is touched by the user with a finger. For example, a system capable of detecting a plurality of touch positions at the same time, such as a capacitive system, is employed for the touch sensor panel 304.

The touch sensor interface 306 is an interface that supplies coordinate data detected by the touch sensor panel 304 to the CPU 301 via the system bus 308

The communication interface 307 is an interface for communication with the information reproduction apparatus 10. The communication with the information reproduction apparatus 10 may be of a wired type or may be of a wireless type. The wireless type includes, for example, a wireless LAN (Local Area Network) such as Wi-Fi (registered trademark), short-distance wireless communication, for example, NFC (Near field communication), Bluetooth (registered trademark), and the like.

The system bus 308 is a transmission path for exchange of various signals between the above-mentioned blocks.

(GUI of Operation Input Apparatus 30)

Next, a GUI (Graphical User Interface) displayed on the display 303 of the operation input apparatus 30 in order to receive, from the user, commands for causing the information reproduction apparatus 10 to execute reproduction of information, movement (jump) of a reproduction position, fast-forward reproduction, and the like will be described.

FIG. 3 is a diagram showing an example of the GUI displayed on the display 303 of the operation input apparatus 30.

As shown in the figure, this GUI includes a dial 41 (rotational operation element), operation mode indications 42J, 42S, and an operation button/status indication 43.

The dial 41 is an operation element rotationally operated in accordance with a jog operation and a shuttle operation with a position of a rotation center C of the dial 41 being fixed. The dial 41 is an element of the GUI, and hence the “rotational operation” means that an image of the dial 41 rotates actually. For enabling the user to recognize the rotation of the dial 41, a mark M deviated from the rotation center C of the dial 41 is disposed at a position in a dial 41 surface, for example. This mark M turns with respect to the rotation center C of the dial 41 along with the rotation of the dial 41.

A typical operation method for the dial 41 using the GUI includes a jog operation of touching the dial 41 surface with, for example, one finger and rotating it, a shuttle operation of putting, for example, two or more fingers on the dial 41 surface and rotating it in a twisting manner, and the like. The CPU 301 is capable of performing, in a manner that depends on the number of fingers touching the dial 41 surface, switching between a jog operation mode for generating a jump command for causing a reproduction position of information that is a reproduction target to jump by a distance depending on an operation rotational angle of the dial 41 and a shuttle operation mode for generating a fast-forward command for fast-forward-reproducing information at a speed depending on the operation rotational angle of the dial 41.

The operation mode indications 42J, 42S are portions that indicate that the currently set operation mode is the jog operation mode or the shuttle operation mode. For example, the operation mode indications 42J, 42S include a jog operation mode indication 42J showing the jog operation mode by changing in form such as luminance, color, size, and the like and a shuttle operation mode indication 42S showing the shuttle operation mode by changing in form such as luminance, color, size, and the like.

The operation button/status indication 43 is an operation button group capable of receiving commands for reproduction, jump, fast-forward, stop, record, and the like of information from the user. The operation button/status indication 43 presents a processing state (status) of reproduction-target information in the information reproduction apparatus 10 to the user.

(Jog Operation of Dial 41)

Next, the jog operation of the dial 41 will be described.

FIG. 4A is a diagram showing a state at a start time of the jog operation. At this time, the mark M of the dial 41 is at a twelve o'clock position of a clock.

The user touches the dial 41 surface with one finger F1. The touch sensor panel 304 generates coordinate data of a position touched with the finger F1. The coordinate data detected by the touch sensor panel 304 is supplied to the CPU 301 through the touch sensor interface 306. If a single piece of coordinate data is supplied by the touch sensor panel 304 through the touch sensor interface 306, the CPU 301 sets the jog operation mode, enables the jog operation mode indication 42J, and saves the coordinate data at the start time of the jog operation in the main memory 302.

Next, it is assumed that, as shown in FIG. 4B, the user performs a jog operation of rotationally moving the finger F1 by an arbitrary angle in a clockwise direction while still touching the dial 41 surface with the finger F1. The CPU 301 receives a series of coordinate data detected by the touch sensor panel 304 due to this jog operation. Then, the CPU 301 saves the last coordinate data detected immediately before the user moves the finger F1 away from the dial 41 surface, as coordinate data at an end time of the jog operation in the main memory 302.

Next, the CPU 301 calculates a rotational operation angle of the dial 41 on the basis of the coordinate data at the start time of the jog operation and the coordinate data at the end time of the jog operation, which are stored in the main memory 302.

FIG. 5 is a diagram showing a calculation method of a rotational operation angle of the rotational operation angle of the dial 41 according to a jog operation.

Here, (Xa0, Ya0) are coordinates of the finger at the start time of the jog operation and (Xa1, Ya1) are coordinates of the finger at the end time of the jog operation. The CPU 301 calculates an angle θ1 formed by a straight line linking the coordinates (Xa0, Ya0) of the finger at the start time of the jog operation to the rotation center C of the dial 41 and a straight line linking the coordinates (Xa1, Ya1) of the finger at the end time of the jog operation to the rotation center C of the dial 41 as a jog-operation rotational angle.

Note that the image of the dial 41 is also rotated due to the jog operation of the dial 41. That is, the mark M in the dial 41 turns by an amount corresponding to the jog-operation rotational angle θ1 in a direction of rotation of the jog operation. Here, a rotated position of the mark M in the dial 41 corresponds to a position of the reproduction-target information on the time axis. For example, a twelve-o'clock position of the dial 41 corresponds to a top position of the reproduction-target information and a six-o'clock position of the dial 41 corresponds to a middle position of the reproduction-target information on the time axis. In addition, a position immediately before the mark M returns to the twelve-o'clock position in a single rotation corresponds to a position immediately before the end of the reproduction-target information.

Next, the CPU 301 generates a jump command on the basis of the jog-operation rotational angle θ1. This jump command is configured with information about a value such as an occupation ratio of the jog-operation rotational angle θ1 in an angle (360 degrees) corresponding to a single rotation of the dial 41, for example.

The CPU 301 sends the generated jump command to the information reproduction apparatus 10 by using the communication interface 307. When receiving this jump command, the information reproduction apparatus 10 may calculate, on the basis of the information stored in this jump command, a position after jump of the information that is the reproduction target, and execute jump to that position and reproduce the information. Alternatively, the information reproduction apparatus 10 may pause (temporarily stop) it at the position after jump.

When a next jog operation is performed with the user's finger F1 touching the dial 41 surface and the jog-operation rotational angle θ1 is updated, the CPU 301 saves coordinate data of the finger F1 newly detected by the touch sensor panel 304 in the main memory 302 as coordinate data of the finger F1 at an end time of a new jog operation. The CPU 301 calculates a new jog-operation rotational angle θ1 on the basis of the coordinate data of the finger F1 at the end time of this new jog operation and the coordinate data of the finger F1 at the start time of the jog operation. The CPU 301 generates a next jump command on the basis of this new jog-operation rotational angle θ1 and sends it to the information reproduction apparatus 10 by using the communication interface 307.

When receiving the next jump command, the information reproduction apparatus 10 calculates a position after jump of the information that is the reproduction target on the basis of the information stored in this jump command, and executes jump to that position and reproduces the information. Alternatively, the information reproduction apparatus 10 may pause (temporarily stop) it at the position after jump.

In this manner, it is possible to freely select the position of the information to be reproduced in the information reproduction apparatus 10, in accordance with the jog operation of the dial 41, and execute jump.

(Shuttle Operation of Dial 41)

Next, a shuttle operation of the dial 41 will be described.

FIG. 6A is a diagram showing a state at a start time of the shuttle operation.

The user touches the dial 41 surface with two fingers F1, F2. The touch sensor panel 304 generates coordinate data of each of positions touched with the two fingers F1, F2. Two pieces of coordinate data detected by the touch sensor panel 304 are supplied to the CPU 301 through the touch sensor interface 306. If two pieces of coordinate data are supplied by the touch sensor panel 304 through the touch sensor interface 306, the CPU 301 sets the shuttle operation mode, enables the shuttle operation mode indication 42S, and saves the pieces of coordinate data of the two fingers F1, F2 at the start time of the shuttle operation in the main memory 302.

Next, it is assumed that, as shown in FIG. 6B, the user performs a shuttle operation of rotationally moving the dial 41 surface in the clockwise direction in a twisting manner while still touching the dial 41 surface with the two fingers F1, F2. The CPU 301 saves the two pieces of coordinate data newly detected by the touch sensor panel 304 along with this shuttle operation as the pieces of coordinate data of the two fingers F1, F2 in the shuttle operation in the main memory 302.

Here, the CPU 301 may be configured to acquire the coordinate data of the positions of the two fingers F1, F2 in the shuttle operation in a predetermined time cycle or may be configured to acquire it when significant movements of the two fingers F1, F2 do not occur during a certain period of time.

Note that the image of the dial 41 is also rotated due to the shuttle operation of the dial 41. That is, the mark M in the dial 41 turns by a distance depending on a rotational angle of the shuttle operation. With this, the user can feel himself or herself rotating the dial 41 that is a part of the GUI by performing the shuttle operation.

FIG. 7 is a diagram showing a calculation method of the rotational operation angle of the dial 41 according to the shuttle operation

Here, (Xa0, Ya0) and (Xb0, Yb0) are coordinates of the two fingers F1, F2 at the start time of the shuttle operation and (Xa1, Ya1) and (Xb1, Yb1) are coordinates of the two fingers F1, F2 in the shuttle operation.

The CPU 301 calculates an angle θ2 formed by a straight line linking the coordinates (Xa0, Ya0), (Xb0, Yb0) of the two fingers F1, F2 at the start time of the shuttle operation to each other and a straight line linking the coordinates (Xa1, Ya1), (Xb1, Yb1) of the two fingers F1, F2 in the shuttle operation to each other, as a shuttle-operation rotational angle.

Next, the CPU 301 determines a speed depending on the shuttle-operation rotational angle θ2. The speed is, for example, a speed proportional to the shuttle-operation rotational angle θ2. The CPU 301 generates a fast-forward command storing information about the determined speed, and sends this fast-forward command to the information reproduction apparatus 10 by using the communication interface 307.

When receiving the fast-forward command from the operation input apparatus 30, the information reproduction apparatus 10 fast-forward-reproduces the information that is the reproduction target at the speed indicated by the speed information stored in this fast-forward command.

When a next shuttle operation is performed with the two fingers F1, F2 touching the dial 41 surface and the shuttle-operation rotational angle θ2 is updated, the CPU 301 saves pieces of coordinate data of the two fingers F1, F2, which are newly detected by the touch sensor panel 304, as two pieces of coordinate data in a new shuttle operation in the main memory 302. The CPU 301 calculates a new shuttle-operation rotational angle θ2 on the basis of the two pieces of coordinate data in the new shuttle operation and the two pieces of coordinate data at the start time of the shuttle operation, which are saved in the main memory 302. The CPU 301 determines a speed depending on the calculated new shuttle-operation rotational angle, generates a fast-forward command storing information about the determined speed, and sends the generated fast-forward command to the information reproduction apparatus 10 by using the communication interface 307.

With this, it is possible to dynamically change the speed of the fast-forward reproduction in accordance with the user's shuttle operation of the dial 41.

The fast-forward reproduction in the information reproduction apparatus 10 is terminated, for example, when the CPU 301 detects that the two fingers F1, F2 touching the dial 41 surface of the operation input apparatus 30 has been moved away from the dial 41 surface. That is, if determining that the pieces of coordinate data of the two fingers F1, F2 are not detected during a certain period of time on the set shuttle operation mode, the CPU 301 terminates (cancels) the shuttle operation mode and sends a command for terminating the fast-forward reproduction to the information reproduction apparatus 10 by using the communication interface 307.

When receiving this command, the information reproduction apparatus 10 terminates the fast-forward reproduction. Then, for example, a normal reproduction (reproduction at equal speed) or pause (temporary stop) state is obtained.

(Switching between Shuttle Operation and Jog Operation of Dial 41)

FIG. 8 is a flowchart about a switching operation of the operation mode of the dial 41 by the operation input apparatus 30 of this embodiment.

The CPU 301 determines whether or not the number of fingers touching the dial 41 surface has changed on the basis of coordinate data input from the touch sensor panel 304. If determining that the number of fingers has changed, the CPU 301 performs switching control of the operation mode of the dial 41 on the basis of a relationship between the number of fingers before change and the number of fingers after change as follows.

1. If the number of fingers touching the dial 41 surface changes from “0” to “1”, the CPU 301 starts the jog operation mode (Step S101→S102→S103).

2. If the number of fingers touching the dial 41 surface changes “0” to “2”, the CPU 301 starts the shuttle operation mode (Step S101→S102→S104).

3. If the number of fingers touching the dial 41 surface changes “1” to “2”, the CPU 301 performs switching from the jog operation mode to the shuttle operation mode (Step S101→S105→S106).

4. If the number of fingers touching the dial 41 surface changes “1” to “0”, the CPU 301 terminates (cancels) the jog operation mode (Step S101→S105→S107).

5. If the number of fingers touching the dial 41 surface changes “2” to “0”, the CPU 301 terminates (cancels) the shuttle operation mode (Step S101→S108→S109).

6. If the number of fingers touching the dial 41 surface changes “2” to “1”, the CPU 301 performs switching from the jog operation mode to the shuttle operation mode (Step S101→S108→S110).

As described above, in accordance with the operation input apparatus 30 of this embodiment, it is possible to perform switching of the operation with respect to the single dial 41 between the jog operation mode for generating the jump command for jumping the reproduction position of the information that is the reproduction target by the distance depending on the operation rotational angle of the dial 41 and the shuttle operation mode for generating the fast-forward command for fast-forward-reproducing the information at the speed depending on the operation rotational angle of the dial 41.

Further, it is only necessary to change the number of fingers touching the dial 41 surface for switching between the jog operation mode and the shuttle operation mode. Therefore, the user can perform switching between the jog operation mode and the shuttle operation mode without largely moving hands, which is an improvement in operability.

<Modified Example 1>

In the above-mentioned embodiment, the jog operation mode is set when the number of fingers touching the dial 41 surface is “1” and the shuttle operation mode is set when it is “2”. However, the present technology is not limited thereto. For example, when the number of fingers touching the dial 41 surface is equal to or larger than “2”, the shuttle operation mode may be set. Further, the number of fingers with which the jog operation mode is set does not necessarily need to be “1”. For example, in a case where the shuttle operation mode is set when the number of fingers touching the dial 41 surface is equal to or larger than “3”, the jog operation mode does not need to be set when the number of fingers touching the dial 41 surface is equal to or smaller than “2”.

In other words, the jog operation mode is set when the number of fingers touching the dial 41 surface is M (M is a number equal to or larger than 1), and the shuttle operation mode is set when the number of fingers touching the dial 41 surface is N (N is a predetermined number larger than M).

<Modified Example 2>

Further, the present technology is not limited to application to the operation input apparatus 30 separated from the information reproduction apparatus 10 as described in the first embodiment. For example, as shown in FIG. 9, a GUI 30A including a dial may be displayed on a screen of a display apparatus 20A with a touch sensor panel, which is connected to an information processing apparatus 10A having a function of information reproduction, under the control of a processor 12 of the information processing apparatus 10A.

The information processing apparatus 10A includes a touch sensor interface 15A. A program is stored in a memory 121A within the processor 12A of the information processing apparatus 10A. A CPU 122A (control circuit) within the processor 12A inputs, in accordance with the program, coordinate data of a position of a user's finger detected by the touch sensor panel of the display apparatus 20A with the touch sensor panel through the touch sensor interface 15A. Then, the CPU 122A (control circuit) performs switching between the jog operation mode and the shuttle operation mode in a manner that depends on the number of fingers toughing a dial surface of the GUI 30A displayed on the screen of the display apparatus 20A with the touch sensor panel.

It should be noted that the present technology may also take the following configurations.

(1) An operation input apparatus, including:

a display unit including a display screen;

a touch sensor panel disposed on the display screen; and

a control circuit that
performs control to display a rotational operation element on the display screen,
determines the number of operation points according to a user's touch with respect to the rotational operation element on the basis of an output of the touch sensor panel, and
performs, on the basis of the determined number of operation points, switching between a first operation mode for generating a jump command for jumping a reproduction position of information that is a reproduction target by a distance depending on an operation rotational angle of the rotational operation element and a second operation mode for generating a fast-forward command for fast-forward-reproducing the information at a speed depending on the operation rotational angle of the rotational operation element.

(2) The operation input apparatus according to (1), in which

the control circuit is configured to
set the first operation mode when the determined number of operation points is M (M is a number equal to or larger than 1), and
set the second operation mode when the determined number of operation points is N (N is a predetermined number larger than M).

(3) The operation input apparatus according to (1) or (2), in which

the control circuit is
configured to perform switching to set the second operation mode when the number of operation points according to the user's touch with respect to the rotational operation element is changed from M to N on the set first operation mode, and
configured to perform switching to set the first operation mode when the number of operation points according to the user's touch with respect to the rotational operation element is changed from N to M on the set second operation mode.

(4) The operation input apparatus according to any of (1) to (3), further including

a communication interface for communication with an information reproduction apparatus capable of reproducing information, in which

the control circuit is configured to
send the generated jump command to the information reproduction apparatus by using the communication interface on the set first operation mode, and
send the generated fast-forward command to the information reproduction apparatus by using the communication interface on the set second operation mode.

### REFERENCE SIGNS LIST

10 information reproduction apparatus

11 storage

12 processor

14 communication interface

20 display apparatus

22 CPU

30 operation input apparatus

41 dial

301 CPU

302 main memory

303 display

304 touch sensor panel

305 display control unit

306 touch sensor interface

307 communication interface

10A information processing apparatus

12A processor

121A memory

122A CPU

15A touch sensor interface

20A display apparatus with touch sensor panel

31A dial

1. An operation input apparatus, comprising:
a display unit including a display screen;
a touch sensor panel disposed on the display screen; and
a control circuit that
performs control to display a rotational operation element on the display screen,
determines the number of operation points according to a user's touch with respect to the rotational operation element on the basis of an output of the touch sensor panel, and
performs, on the basis of the determined number of operation points, switching between a first operation mode for generating a jump command for jumping a reproduction position of information that is a reproduction target by a distance depending on an operation rotational angle of the rotational operation element and a second operation mode for generating a fast-forward command for fast-forward-reproducing the information at a speed depending on the operation rotational angle of the rotational operation element.

2. The operation input apparatus according to claim 1, wherein
the control circuit is configured to
set the first operation mode when the determined number of operation points is M (M is a number equal to or larger than 1), and
set the second operation mode when the determined number of operation points is N (N is a predetermined number larger than M).

3. The operation input apparatus according to claim 2, wherein
the control circuit is
configured to perform switching to set the second operation mode when the number of operation points according to the user's touch with respect to the rotational operation element is changed from M to N on the set first operation mode, and
configured to perform switching to set the first operation mode when the number of operation points according to the user's touch with respect to the rotational operation element is changed from N to M on the set second operation mode.

4. The operation input apparatus according to claim 3, further comprising
a communication interface for communication with an information reproduction apparatus capable of reproducing information, wherein
the control circuit is configured to
send the generated jump command to the information reproduction apparatus by using the communication interface on the set first operation mode, and
send the generated fast-forward command to the information reproduction apparatus by using the communication interface on the set second operation mode.

5. The operation input apparatus according to claim 4, wherein
the control circuit is configured to
cancel the set first operation mode when the number of operation points according to the user's touch with respect to the rotational operation element is changed from M to 0 on the set first operation mode,
cancel the set second operation mode, generate a command for terminating the fast-forward reproduction of the information, and send the command to the information reproduction apparatus by using the communication interface, when the number of operation points according to the user's touch with respect to the rotational operation element is changed from N to 0 on the set second operation mode.

6. An information processing apparatus, comprising
a control circuit that
performs control to display a rotational operation element on a display screen of a display apparatus,
determines the number of operation points according to a user's touch with respect to the rotational operation element on the basis of an output of a touch sensor panel disposed on the display screen of the display apparatus, and
performs, on the basis of the determined number of operation points, switching between a first operation mode for generating a jump command for jumping a reproduction position of information that is a reproduction target by a distance depending on an operation rotational angle of the rotational operation element and a second operation mode for generating a fast-forward command for fast-forward-reproducing the information at a speed depending on the operation rotational angle of the rotational operation element.

7. An information processing method, comprising:
by a control circuit
performing control to display a rotational operation element on a display screen of a display apparatus;
determining the number of operation points according to a user's touch with respect to the rotational operation element on the basis of an output of a touch sensor panel disposed on the display screen of the display apparatus; and
performing, on the basis of the determined number of operation points, switching between a first operation mode for generating a jump command for jumping a reproduction position of information that is a reproduction target by a distance depending on an operation rotational angle of the rotational operation element and a second operation mode for generating a fast-forward command for fast-forward-reproducing the information at a speed depending on the operation rotational angle of the rotational operation element.

8. A program that causes a computer as
a control circuit that
performs control to display a rotational operation element on a display screen of a display apparatus,
determines the number of operation points according to a user's touch with respect to the rotational operation element on the basis of an output of a touch sensor panel disposed on the display screen of the display apparatus, and
performs, on the basis of the determined number of operation points, switching between a first operation mode for generating a jump command for jumping a reproduction position of information that is a reproduction target by a distance depending on an operation rotational angle of the rotational operation element and a second operation mode for generating a fast-forward command for fast-forward-reproducing the information at a speed depending on the operation rotational angle of the rotational operation element.
